(19) United States
(12) Patent Application Publication
(10) Pub. No.: US 2009/0228839 A1
(43) Pub. Date: Sep. 10, 2009

(54) Plant information display apparatus and method

(75) Inventor: Ryotatsu Iga, Tokyo (JP)

Correspondence Address: EDWARDS ANGELL PALMER & DODGE LLP, P.O. BOX 55874, BOSTON, MA, 02205, US

(73) Assignee: Yokogawa Electric Corporation, Musashino-shi (JP)

(21) Appl. No.: 12/381,232

(22) Filed: Mar. 10, 2009

(30) Foreign Application Priority Data
Mar. 10, 2008 (JP) 2008-059642

(51) Int. Cl. G06F 3/048

(52) U.S. Cl. 715/853

(57) ABSTRACT

A plant information display apparatus and a plant information display method are provided. A defining section 11 defines correspondence relationships between all of plant data and softwares displaying the corresponding plant data. A plant data displaying section 12 expands and displays the plant data in a hierarchical manner. A plant data selection accepting section 13 accepts an operation of selecting the plant data on the screen displayed by the plant data displaying section 12. A software selection accepting section 14 displays a selecting screen for selecting one of the softwares, and accepts an operation of selecting the one of the softwares in accordance with an operation of the selecting screen. A extracting section 15 extracts the software or plant data based on the defining section 11.

This application claims priority from Japanese Patent Application No. 2008-059642, filed on Mar. 10, 2008, the entire contents of which are hereby incorporated by reference.

### BACKGROUND OF THE INVENTION

1. Technical Field

The present disclosure relates to a plant information display apparatus and plant information display method. More particularly, the present disclosure relates to a plant information display apparatus and plant information display method which display information related to plant data on a screen by selectively using a plurality of kinds of softwares having mutually different display styles.

2. Related Art

A plant utilizes a large number of equipment data and process data. Also, a large number of tools are available for performing functions required for process operations using such data. When any operation related to plant operations is to be performed, the operator activates a corresponding tool, and performs an operation of designating data or the like, thereby acquiring a display screen and the like required for the operation (see, e.g., JP-A-2007-264861)

In the related-art system, however, functions required for the operations are incorporated in a distributed manner in various tools, and therefore complicated operations are required for reaching a target operation. In order to activate the tool for the target action, moreover, it is necessary to perfectly know distributed menus and locations of execution files. In the respective tools, arguments to be applied for startup and manners of operation are implemented according to original specifications. In some tools, for example, it is necessary to manually input a startup argument, so that the operations require some learning and skills.

### SUMMARY

Exemplary embodiments of the present invention address the foregoing issues and other issues not described above. However, the present invention is not required to overcome the problems described above and, thus, some implementations of the present invention may not overcome the specific problems described above.

Accordingly, it is an aspect of the present invention to provide a plant information display apparatus and method which have good operability and from which target information can be easily obtained.

According to one or more aspects of the present invention, there is provided a plant information display apparatus which displays information related to plant data on a screen by selectively using a plurality of kinds of softwares each having a different display style and displaying the plant data. The plant information display apparatus includes: a defining section configured to define correspondence relationships between the plant data and the softwares; a plant data displaying section configured to expand and display the plant data in a hierarchical manner; a plant data selection accepting section configured to accept an operation of selecting the plant data on the screen displayed by the plant data displaying section; an extracting section configured to extract the softwares based on the defining section, the softwares displaying the plant data selected by the plant data selection accepting section; a software selection accepting section configured to display a selecting screen for selecting one of the softwares extracted by the extracting section, and accept an operation of selecting said one of the softwares in accordance with an operation on the selecting screen; and an information displaying section configured to display, on the screen, information related to the plant data selected by the plant data selection accepting section by using said one of the software.

According to one or more aspects of the present invention, there is provided a plant information display apparatus which displays information related to plant data on a screen by selectively using a plurality of kinds of softwares each having a different display style and displaying the plant data. The plant information display apparatus includes: a defining section configured to define correspondence relationships between the plant data and the softwares; a software selection accepting section configured to display a selecting screen for selecting one of the softwares, and accept an operation of selecting said one of the softwares in accordance with an operation on the selecting screen; an extracting section configured to extract the plant data based on the defining section, the plant data being displayed by said one of the softwares; a plant data displaying section configured to expand and display the plant data extracted by the extracting section, in a hierarchical manner; a plant data selection accepting section configured to accept an operation of selecting the plant data on the screen displayed by the plant data display section; and an information displaying section configured to display, on the screen, information related to the plant data selected by the plant data selection accepting section by using said one of the softwares.

According to one or more aspects of the present invention, there is provided a plant information display method of displaying information related to plant data on a screen by selectively using a plurality of kinds of softwares each having a different display style and displaying the plant data. The method includes: (a) defining correspondence relationships between the plant data and the softwares; (b) expanding and displaying the plant data in a hierarchical manner; (c) accepting an operation of selecting the plant data on the screen displayed in step (b); (d) extracting the softwares based on the defined correspondence relationships, the softwares displaying the plant data selected in step (c); (e) displaying a selecting screen for selecting one of the extracted softwares, and accepting an operation of selecting said one of the softwares in accordance with an operation on the selecting screen; and (f) displaying, on the screen, information related to the plant data selected in step (c), by using said one of the softwares selected in step (e).

According to one or more aspects of the present invention, there is provided a plant information display method of displaying information related to plant data on a screen by selectively using a plurality of kinds of softwares each having a different display style and displaying the plant data. The method includes: (a) defining correspondence relationships between the plant data and the softwares; (b) displaying a selecting screen for selecting one of the softwares, and accepting an operation of selecting said one of the softwares in accordance with an operation on the selecting screen; (c) extracting the plant data based on the correspondence relationships, the plant data being displayed by said one of the softwares; (d) expanding and displaying the plant data extracted in a hierarchical manner; (e) accepting an operation of selecting the plant data on the screen displayed in step (d); and (f) displaying, on the screen, information related to the plant data selected in step (e), by using said one of the softwares selected in step (b).

### BRIEF DESCRIPTION OF THE DRAWINGS

FIG. 1 is a block diagram showing the configuration of a field control system using a plant information display apparatus according to an embodiment of the present invention;

FIG. 2 is a view showing a launch bar displayed on an operation monitoring screen;

FIG. 3 is a view showing a screen that displays a trend graph of a plurality of selected plant data;

FIG. 4 is a view showing a state that a tab of “PLANT” is selected; and

FIG. 5 is a view showing a search screen.

### DETAILED DESCRIPTION OF EXEMPLARY EMBODIMENTS OF THE INVENTION

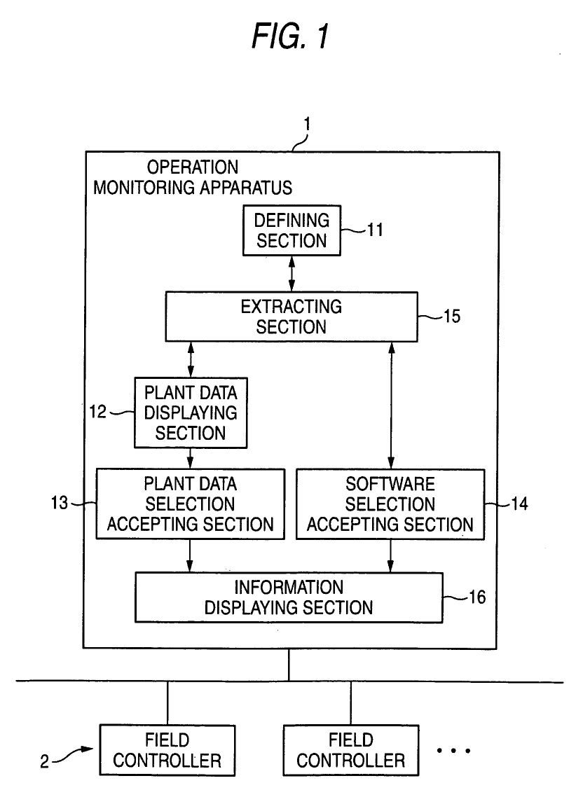

Hereinafter, an exemplary embodiment of the plant information display apparatus of the invention will be described with reference to FIGS. 1 to 5.

FIG. 1 is a block diagram showing the configuration of a field control system using the plant information display apparatus according to an exemplary embodiment of the invention.

As shown in FIG. 1, the field control system includes field controllers 2, 2, . . . which are disposed in a distributed manner in a plant, and an operation monitoring apparatus 1 which collects plant data of field equipment via the field controllers 2, 2, . . . , and then performs operations and monitoring for operating the plant.

As shown in FIG. 1, the operation monitoring apparatus 1 includes: a defining section 11 configured to define correspondence relationships between all of plant data and softwares (tools, menus, and the like) in which the plant data are to be displayed; a plant data displaying section 12 configured to expand and display the plant data in a hierarchical manner; a plant data selection accepting section 13 configured to accept an operation of selecting the plant data on the screen displayed by the plant data displaying section 12; a software selection accepting section 14 configured to display a screen for selecting a specific one of the softwares and then accept the operation of selecting one of the softwares by an operation on the screen; an extracting section 15 configured to extract the software or the plant data based on the defining section 11; and an information displaying section 16 configured to display, on the screen, information related to the plant data selected via the plant data selection accepting section 13 by using the software selected via the software selection accepting section 14.

Next, the display operation in the operation monitoring apparatus 1 will be described.

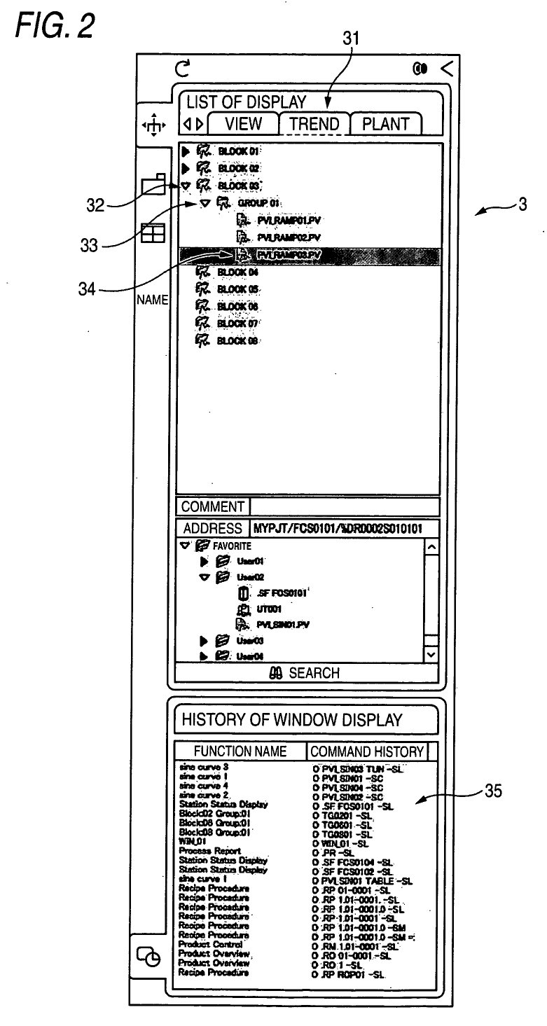

FIG. 2 is a view showing a launch bar 3 displayed on an operation monitoring screen of the operation monitoring apparatus 1. The launch bar 3 is displayed by the plant data displaying section 12 and the software selection accepting section 14. The launch bar 3 makes an intensive list of tools, menus, and the like related to the plant operation. The launch bar 3 is a resident bar on the right or left side of the operation monitoring screen, and automatically minimized except for a time when it is needed, in order not to interfere with the operation of the operator. The tools, menus, and the like are stored in the launch bar 3 as tabs in the unit of function, and can be switched by selecting a tab.

The launch bar 3 functions as a base point of the operation by the operator. When any action related to the plant operation is to be performed, the operator can expand an operation from a tab corresponding to the target action in the launch bar 3. Each node of the launch bar 3 is provided with a function of assigning a function to another function by means of drag and drop, and context menus by which various tools can be automatically activated while omitting an input of startup arguments.

FIG. 2 shows a state that a tab 31 of “TREND” is selected. The “TREND” corresponds to a tool for displaying a trend of the plant data. When the tab 31 of “TREND” is selected, the extracting section 15 extracts plant data which are intended to be displayed as the trend by the tool for the trend display based on the defining section 11, and the plant data displaying section 12 displays the extracted plant data in a tree hierarchical structure.

When the operator operates an icon of plant data displayed in a hierarchical manner, so as to expand and display the plant data, and then selects an icon of specific plant data, the software selection accepting section 14 accepts the operation as an operation of selecting the tool corresponding to the selected tab, and the plant data selection accepting section 13 accepts the operation as an operation of selecting plant data corresponding to the operated icon.

In the example of FIG. 2, “BLOCK 03” is expanded by operating an icon 32, and “GROUP 01” is expanded by operating an icon 33. Thus, the plant data belonging to “GROUP 01” are expanded and displayed. By operating an icon 34, plant data corresponding to a process tag of “PVI_RAMP03.PV” are selected.

In a region 35 of the launch bar 3, a history of operations executed through the launch bar 3 is displayed.

Next, the information displaying section 16 activates the tool selected via the software selection accepting section 14, and displays information related to the plant data selected via the plant data selection accepting section 13, on the screen. In the case of FIG. 2, due to the function of the tool for the trend display, a trend graph of the plant data corresponding to the tag of “PVI_RAMP03.PV” is displayed.

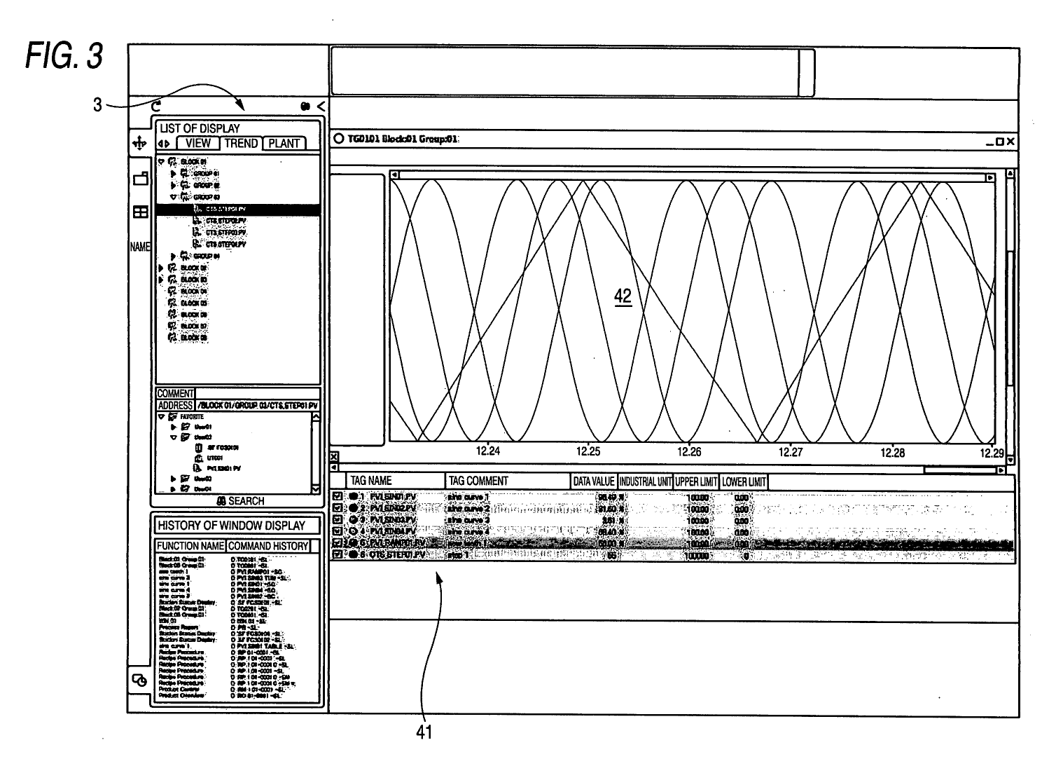

Also, it is possible to select a plurality of plant data and to display a plurality of trend graphs on one screen. FIG. 3 shows a state that the plant data are expanded and displayed by the method described with reference to FIG. 2, and the plant data are selected by copying the icon of the plant data to the region 41 by means of drag and drop. In the example of FIG. 3, a plurality of plant data are selected, and operation results (trend graphs) performed by the tool for trend display of the selected plant data are displayed in a region 42.

As described above, the operator can successively perform designation of tools and that of process tags in the plant, only by operations on the launch bar 3.

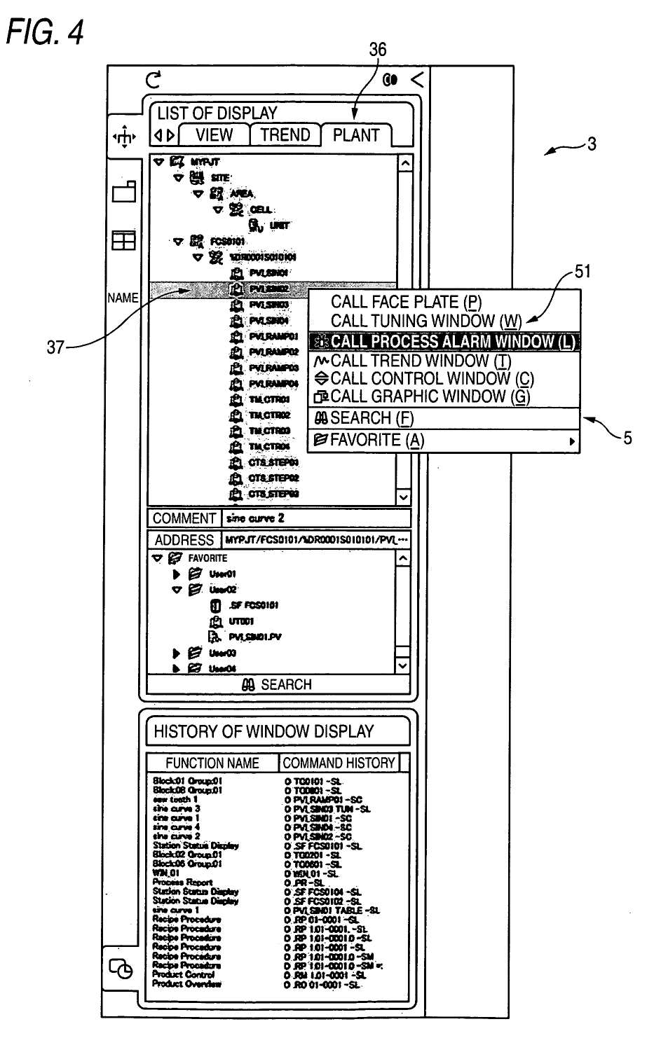

FIG. 4 shows a state that a tab 36 of “PLANT” is selected. When the tab 36 of “PLANT” is selected, the plant data displaying section 12 displays all of the plant data in the plant registered in the defining section 11 in such a manner that the plant data can be expanded in accordance with the tree plant hierarchy. In the example of FIG. 4, after the required expanding operation, the plant data corresponding to a process tag of “PVI_SIN02” is selected by the operation of an icon 37.

When the icon 37 is right-clicked in this state, the software selection accepting section 14 displays a context menu 5 by which various tools can be activated while omitting the input of startup arguments. When the context menu 5 is to be displayed, the extracting section 15 extracts all of the tools available for the selected tag of “PVI_SIN02” based on the defining section 11. The software selection accepting section 14 displays only the extracted tools in the context menu 5.

The software selection accepting section 14 accepts a selection operation which is performed on a tool in the context menu 5 by the operator. In the operation of selecting a tool, the plant data selection accepting section 13 accepts an operation of selecting the corresponding tag, i.e., a process tag corresponding to the icon 37.

Next, the information display means 16 activates the tool selected via the software selection accepting section 14, and displays the information related to the plant data selected via the plant data selection accepting section 13, on the screen.

As described above, the operator can first designate a certain specific process tag in the plant, and then select the tool to be applied. In the case where a parameter is to be adjusted for a specific process tag, for example, the icon of the process tag is right-clicked and the context menu 5 is expanded, and, when an icon 51 is then selected, a tool for parameter tuning (a tuning window) is opened. As described above, in order to successively designate tags in the plant and designate tools, the operator is requested to perform only an operation on the launch bar 3.

As described above, according to the plant information display apparatus of the exemplary embodiment, the callings of various functions which are conventionally distributed in the operation monitoring screen are intensively listed in one launch bar, so that the operation efficiency can be improved.

In addition, plant data can be designated while the data are expanded and displayed in the hierarchical manner, or data can be designated by an operation of drag and drop, or the like, so that it is possible to perform the data access through intuition. Furthermore, a tool can be selected by an operation such as a selection of a tag, or right clocking, so that it is possible to select the tool through intuition. Accordingly, the target information can be easily obtained without requiring any learning for the operation.

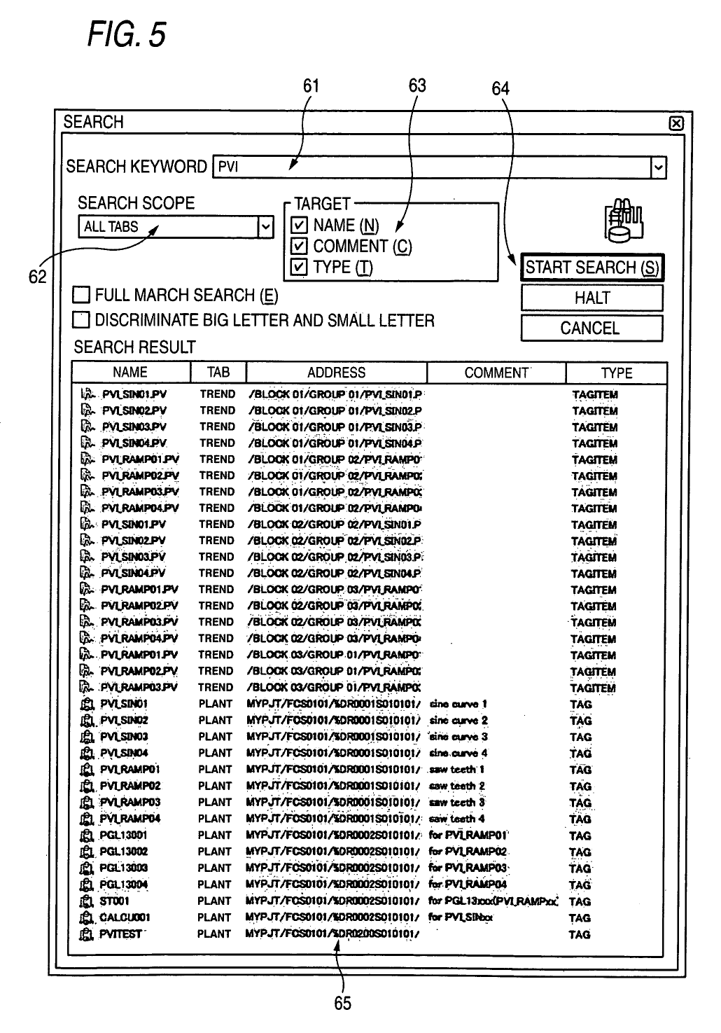

In addition, when all of the process data are registered in the defining section 11, the function of displaying a list of the plant data can be intensively provided for only the launch bar. Therefore, the retrieval of data can be performed for all of the process data in the plant. FIG. 5 shows the search screen. A keyword to be searched is designated in a region 61, an area to be searched is designated in a region 62, and a search object is designated in a region 63. When a search start button 64 is then operated, the process data registered in the defining section 11 are searched, and the data matched with the search conditions are extracted and listed in a region 65.

As described above, in the plant information display apparatus according to exemplary embodiments of the invention, the plant data are expanded and displayed in a hierarchical manner, an operation of selecting plant data on the screen is accepted, a software in which the selected plant data are to be displayed is extracted based on the defined correspondence relationships, a screen for selecting a specific one of the extracted softwares is displayed, and an operation of selecting a software is accepted by an operation on the screen, so that the target information can be displayed through a simple operation. According to the plant information apparatus of the invention, moreover, a screen for selecting a specific one of a plurality of kinds of softwares is displayed, an operation of selecting a software is accepted by an operation on the screen, plant data to be displayed by the selected software are extracted based on the defined correspondence relationships, the extracted plant data are expanded and displayed in a hierarchical manner, and an operation of selecting the plant data on the screen is accepted, so that the target information can be displayed through a simple operation.

While the present invention has been shown and described with reference to certain example embodiments, other implementations are within the scope of the claims. It will be understood by those skilled in the art that various changes in form and details may be made therein without departing from the spirit and scope of the invention as defined by the appended claims.

The present invention is widely applicable to a plant information display apparatus and method which display information related to plant data by selectively using a plurality of kinds of softwares having mutually different display styles.

What is claimed is:

1. A plant information display apparatus which displays information related to plant data on a screen by selectively using a plurality of kinds of softwares each having a different display style and displaying the plant data, the plant information display apparatus comprising:
a defining section configured to define correspondence relationships between the plant data and the softwares;
a plant data displaying section configured to expand and display the plant data in a hierarchical manner;
a plant data selection accepting section configured to accept an operation of selecting the plant data on the screen displayed by the plant data displaying section;
an extracting section configured to extract the softwares based on the defining section, the softwares displaying the plant data selected by the plant data selection accepting section;
a software selection accepting section configured to display a selecting screen for selecting one of the softwares extracted by the extracting section, and accept an operation of selecting said one of the softwares in accordance with an operation on the selecting screen; and
an information displaying section configured to display, on the screen, information related to the plant data selected by the plant data selection accepting section by using said one of the software.

2. A plant information display apparatus which displays information related to plant data on a screen by selectively using a plurality of kinds of softwares each having a different display style and displaying the plant data, the plant information display apparatus comprising:
a defining section configured to define correspondence relationships between the plant data and the softwares;
a software selection accepting section configured to display a selecting screen for selecting one of the softwares, and accept an operation of selecting said one of the softwares in accordance with an operation on the selecting screen;
an extracting section configured to extract the plant data based on the defining section, the plant data being displayed by said one of the softwares;
a plant data displaying section configured to expand and display the plant data extracted by the extracting section, in a hierarchical manner;
a plant data selection accepting section configured to accept an operation of selecting the plant data on the screen displayed by the plant data display section; and
an information displaying section configured to display, on the screen, information related to the plant data selected by the plant data selection accepting section by using said one of the softwares.

3. A plant information display method of displaying information related to plant data on a screen by selectively using a plurality of kinds of softwares each having a different display style and displaying the plant data, the method comprising:
(a) defining correspondence relationships between the plant data and the softwares;
(b) expanding and displaying the plant data in a hierarchical manner;
(c) accepting an operation of selecting the plant data on the screen displayed in step (b);
(d) extracting the softwares based on the defined correspondence relationships, the softwares displaying the plant data selected in step (c);
(e) displaying a selecting screen for selecting one of the extracted softwares, and accepting an operation of selecting said one of the softwares in accordance with an operation on the selecting screen; and
(f) displaying, on the screen, information related to the plant data selected in step (c), by using said one of the softwares selected in step (e).

4. A plant information display method of displaying information related to plant data on a screen by selectively using a plurality of kinds of softwares each having a different display style and displaying the plant data, the method comprising:
(a) defining correspondence relationships between the plant data and the softwares;
(b) displaying a selecting screen for selecting one of the softwares, and accepting an operation of selecting said one of the softwares in accordance with an operation on the selecting screen;
(c) extracting the plant data based on the correspondence relationships, the plant data being displayed by said one of the softwares;
(d) expanding and displaying the plant data extracted in a hierarchical manner;
(e) accepting an operation of selecting the plant data on the screen displayed in step (d); and
(f) displaying, on the screen, information related to the plant data selected in step (e), by using said one of the softwares selected in step (b).
